(19) United States
(12) Patent Application Publication
(10) Pub. No.: US 2007/0069898 A1
(43) Pub. Date: Mar. 29, 2007

(54) Glove with attached security device

(76) Inventor: Mark J. White, Lindale, GA (US)

Correspondence Address: NEEDLE & ROSENBERG, P.C., SUITE 1000, 999 PEACHTREE STREET, ATLANTA, GA, 30309-3915, US

(21) Appl. No.: 11/528,024

(22) Filed: Sep. 27, 2006

Related U.S. Application Data
(60) Provisional application No. 60/721,327, filed on Sep. 28, 2005.

(51) Int. Cl. G08B 13/14

(52) U.S. Cl. 340/572.6

(57) ABSTRACT

A glove has a layer of first material, and a layer of second material is attached to the layer of first material to form a pouch. A security tag is provided in the pouch between the layer of first material and the layer of second material. In this manner, the security tag may not be readily apparent to a customer. The layer of first material may include a cuff. The layer of second material may be attached to the layer of first material at the perimeter of the layer of second material. The layer of second material may optionally comprise a label. The method of making the article includes placing a security tag on the layer of first material and covering the security tag with a layer of second material. The layer of second material is sewn to the first material, which encloses the security tag.

### CROSS-REFERENCE TO RELATED APPLICATION

This application claims the benefit of U.S. provisional application(s) No. 60/721,327 filed on Sep. 28, 2005. The aforementioned application(s) is (are) herein incorporated by this reference in its (their) entirety.

### FIELD OF THE INVENTION

The present invention relates generally to the field of use of security devices, such as security tags, with clothing, such as gloves, in a manner that prevents easy removal of the security devices.

### BACKGROUND OF THE INVENTION

Electronic article surveillance (EAS) systems are widely used in commercial and retail establishments to deter theft or other unauthorized removal of articles from the surveillance area. In a commonly used EAS system, articles to be protected carry a security tag or label, which may be affixed on or inside packaging or as a label for the article or item, or on or inside the article or item itself, containing an electronic circuit, such as an inductor/capacitor resonant circuit. The resonant tag circuit is detected or identified by equipment for establishing an RF electromagnetic field in a surveillance zone at the exit of the surveillance area.

The detectable resonant circuit of the EAS tag is a small, generally planar, multi-layer structure having a dielectric substrate and conductive layers on opposite sides of the substrate that define an inductor and at least one capacitor that provide a circuit resonant at at least one predetermined detection frequency. An example of such a security tag is made by Sensormatic Electronics Corporation, and is shown in U.S. Pat. No. 6,919,806.

### SUMMARY OF THE INVENTION

Security tags are often applied to articles by adhesive or on hang tags attached to the articles. Especially in the case of smaller articles, such as clothing, the security tags of this type may be simply removed, with the article being removed without detection by the security system. The present invention overcomes this problem in articles such as gloves, which are not otherwise sold in an enclosed package, by sewing the security tag within a pouch or under a layer of material, so it is not easily removable and so that it is concealed.

### BRIEF DESCRIPTION OF THE FIGURES

The accompanying drawings, which are incorporated in and constitute a part of this specification, illustrate several aspects of the invention and together with the description, serve to explain the principles of the invention.

FIG. 1 is a top view of a glove incorporating the present invention.

FIG. 2 is a top view of a security tag.

FIG. 3 is a partial perspective view of the open end of the glove of FIG. 1.

FIG. 4 is a partial section view of a portion of the glove incorporating the present invention.

### DETAILED DESCRIPTION OF THE INVENTION

The present invention may be understood more readily by reference to the following detailed description of preferred aspects of the invention and to the Figures and their previous and following description.

Before the present articles, compositions, devices, and/or methods are disclosed and described, it is to be understood that this invention is not limited to the specific articles, devices, and/or methods disclosed unless otherwise specified, as such may, of course, vary. It is also to be understood that the terminology used herein is for the purpose of describing particular aspects only and is not intended to be limiting.

As used herein, the singular forms “a,” “an” and “the” include plural referents unless the context clearly dictates otherwise. Thus, for example, reference to “bias member” includes aspects having two or more such bias members unless the context clearly indicates otherwise.

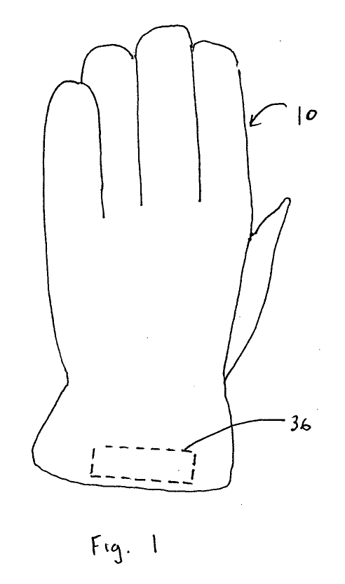

FIG. 1 illustrates an embodiment of the invention as implemented in a glove 10. Many types of gloves are often sold in retail stores in an unpackaged open manner, such as on a display rack, in trays or on shelves. Typical types of gloves sold in this manner include work gloves, gardening gloves or other non-dress type gloves where appearance is not the basic purpose of the glove. Such gloves may be made of leather, synthetic leather, cotton, or cotton blends.

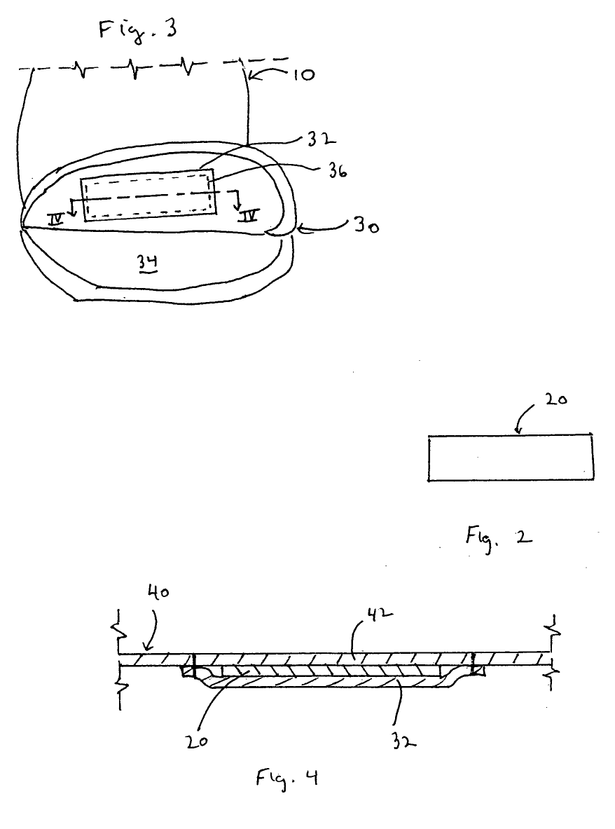

It is now commonplace in retail stores to use EAS systems including security tags placed on or in items sold in such stores to prevent theft of articles. Security tags are usually long thin plastic planar devices as discussed above. FIG. 2 illustrates the typical shape of such a tag 20, showing its upper surface. Most commonly, security tags have an adhesive on their lower surface to allow the tag to be adhered to the product or packaging of products sold in retail stores. Normally, such security tags are exposed to the customers, who are well aware of the security purpose of such tags. One problem, especially with smaller items such as gloves, is that a customer may easily remove the security tag from the item and attempt to hide the item and remove it from the retail store without making payment.

The present invention involves integrating the security tag into the product in a manner where removal is much more difficult and where the tag is hidden in a manner that a customer may not even be aware that it is included in the product. One way to accomplish this in the embodiment discussed herein is to sew another layer of material to the glove such that the security tag is enclosed and not exposed. FIG. 3 illustrates the cuff area 30 of a glove 10, wherein a layer of material 32 is sewn on the inside 34 of the cuff of the glove, and the security tag is between the inside surface 34 of the glove and the material 32 sewn over it. Threads 36 secure the material 32 around the security tag located within.

This is more clearly shown in FIG. 4, which shows a section 40 along line IV-IV of FIG. 3. The layer of glove material 42 in the area of the cuff 30, with the tag 20 being located between the layer of glove material 42 and the other layer of material 32. Thread material 36 surrounds the security tag 20, which is thereby enclosed between layers 42 and 32, such that the security tag 20 is not readily seen or removed.

The material 32 may also comprise a label which identifies the product or provides other information to the purchaser. Alternatively, if the material 32 is a label, it may be located on the outside of the cuff in the area of the thread 36 as seen in FIG. 1. The label may have dimensions greater than the dimensions of the security tag 20 so that the security tag 20 is hidden when the label is attached to the outside of the cuff 30. Also, the material 32 may be of such a thickness that when the label is attached to the cuff, the presence of the security tag between the label and the cuff is not readily apparent. Additionally, even if the material is not a label, the material could be of such dimensions and/or thickness that the location or presence of the security tag between the cuff and the material is not noticeable.

The manufacture of a glove of the embodiment described herein may be constructed in the process of otherwise sewing together the pieces of the glove, whereby the material 32 may be partially sewn to the inside of the cuff 34 such that two or three sides of the material 32 are first sewn to form a pouch. Then the security tag is inserted into the pouch area and the remaining side or sides are sewn to the cuff material 42. Also, the security tag 20 can be placed on the cuff 34, and the second material can be placed on the security tag 20 and the cuff 34. Then the second material may be sewn to the cuff 34, whereby the security tag 20 is enclosed.

Thus, it can be seen that the glove with attached security device described herein provides an improved means for utilizing a security tag with articles to be sold. While the invention is described with respect to gloves, it will be understood that the invention may be implemented with other articles and especially clothing.

To that end, it will be apparent to those skilled in the art that various modifications and variations can be made in the present invention without departing from the scope or spirit of the invention. Other aspects of the invention will be apparent to those skilled in the art from consideration of the specification and practice of the invention disclosed herein.

1. An article, comprising:
an item having a layer of first material;
a layer of second material attached to the layer of first material; and
a security tag located between the layer of first material and the layer of second material.

2. The article of claim 1, wherein the item is a glove.

3. The article of claim 2, wherein the layer of first material comprises the cuff of the glove and the security tag is located in the cuff.

4. The article of claim 1, wherein the first material is selected from a group consisting of leather, synthetic leather, cotton and a cotton blend.

5. The article of claim 1, wherein the layer of second material is attached to the layer of first material by thread.

6. The article of claim 1, wherein the layer of second material has a perimeter, wherein the layer of second material is attached to the layer of first material at the perimeter of the layer of second material, whereby a pouch enclosing the security tag is formed.

7. The article of claim 1, wherein the layer of first material and the layer of second material are opaque, whereby the security tag is hidden.

8. The article of claim 1, wherein the layer of second material is sufficiently thick such that the presence of the security tag between the layers of the first and second material is not readily apparent.

9. The article of claim 1, wherein the layer of second material comprises a label.

10. The article of claim 9, wherein the label has dimensions greater than the security tag such that the security tag is hidden when the label is attached to the layer of first material.

11. The article of claim 9, wherein the label is sufficiently thick so that the presence of the security tag between the layers of the first and second material is not readily apparent.

12. A method, comprising:
placing a security tag on a portion of a layer of first material;
placing a layer of second material covering the security tag; and
sewing the layer of second material to the layer of first material, whereby the security tag is enclosed.

13. The method of claim 12, wherein:
a portion of the layer of first material is sewn onto the layer of second material, wherein a pouch area is formed;
the security tag is placed in the pouch area; and
the remaining portion of the layer of first material is sewn onto to the layer of second material, whereby the security tag is enclosed.

14. An article, comprising:
a glove having a cuff, wherein the cuff has an inside surface;
a layer of material attached to the inside surface of the cuff; and
a security tag located between the inside surface of the cuff and the layer of material attached to the inside surface of the cuff.

15. The article of claim 14, wherein the layer of material is selected from a group consisting of leather, synthetic leather, cotton and a cotton blend.

16. The article of claim 14, wherein the cuff and the layer of material are opaque, whereby the security tag is hidden.

17. The article of claim 14, wherein the layer of second material is sufficiently thick such that the presence of the security tag between the layers of the first and second material is not readily apparent.

18. The article of claim 14, wherein the layer of material comprises a label.

19. The article of claim 19, wherein the label has dimensions greater than the security tag such that the security tag is hidden when the label is attached to the layer of first material.

20. The article of claim 19, wherein the label is sufficiently thick so that the presence of the security tag between the layers of the first and second material is not readily apparent.
